(19) United States
(12) Patent Application Publication
(10) Pub. No.: US 2008/0160295 A1
(43) Pub. Date: Jul. 3, 2008

(54) Method for adjusting ablation threshold

(75) Inventors: Reijo Lappalainen, Hiltulanlahti (FI); Jari Ruuttu, Billnas (FI); Vesa Myllymaki, Helsinki (FI); Juha Makitalo, Tammisaari (FI); Lasse Pulli, Helsinki (FI)

Correspondence Address: BIRCH STEWART KOLASCH & BIRCH, PO BOX 747, FALLS CHURCH, VA, 22040-0747, US

(73) Assignee: PICODEON LTD OY

(21) Appl. No.: 11/783,840

(22) Filed: Apr. 12, 2007

Related U.S. Application Data
(60) Provisional application No. 60/791,222, filed on Apr. 12, 2006.

(51) Int. Cl. B32B 3/00; B29C 35/08

(52) U.S. Cl. 428/332; 264/400

(57) ABSTRACT

The invention pertains to a method for lowering the ablation threshold of a laser-ablated material by having on a surface of the laser-ablated material a structuring which reduces the reflection of a laser beam. The ablation threshold can be further lowered by heating the material as well as by chemically modifying the material or its surface, even slightly. The invention facilitates industrial implementation of machining of a number of various surfaces and materials. The invention also pertains to target materials to be ablated.

### FIELD OF THE INVENTION

This invention pertains to a method for lowering the ablation threshold of a laser-ablated material by having on a surface of the laser-ablated material a structuring which affects the reflection of a laser beam. The invention further pertains to a laser-ablatable target material the ablation threshold of which is considerably lower than normal and which facilitates efficient industrial manufacture of several different surfaces using laser technology.

### PRIOR ART

Laser technology has advanced significantly in the recent years and now it is possible to produce fiber based semiconductor laser systems with a tolerable efficiency which can be used in cold ablation, for example. Such lasers for cold-work include picosecond lasers and femtosecond lasers. In picosecond lasers, for example, the cold-work range refers to pulse lengths of 100 picoseconds or less. Apart from the pulse length, picosecond lasers differ from femtosecond lasers in the repetition frequency; the repetition frequencies of latest commercial picosecond lasers are 1 to 4 MHz, whereas the repetition frequencies of femtosecond lasers are in the kilohertz range. At its best cold ablation enables vaporization of material such that no heat transfers are directed to the material to be vaporized (ablated), i.e. only the pulse energy is directed solely to the material ablated by each pulse.

Competing with the fully fiber based diode pumped semiconductor laser is the lamp pumped laser source in which the laser beam is first conducted into the fiber and thence further to the work spot. According to the information available to the applicant on the priority date of the present application these fiber based laser systems are at the moment the only way to bring about laser ablation based production on an industrial scale.

The fibers of present-day fiber lasers and, hence, the limited beam power impose limitations as to which materials can be vaporized. Aluminum as such can be vaporized using a reasonable pulse power, whereas materials more difficult to vaporize, such as copper, tungsten etc., require a pulse power considerably higher.

Another problem associated with the prior art is the scanning width of the laser beam and the non-uniform scan quality. Generally it has been used line scanning in mirror film scanners whereby, theoretically, one could think that it is possible to achieve a nominal scan line width of about 70 mm, for example, but in practice the scanning width may problematically remain even around 30 mm, whereby the fringe regions of the scanning area may be left uneven in quality and/or different from the central regions. Scanning widths this small also contribute to the fact that the use of present-day laser equipment in surface treatment applications for large and wide objects is industrially unfeasible or technically impossible to implement. In addition, making the scanning width wider, if possible, affects the vaporization power, because the laser power will be distributed across a larger surface area to be vaporized.

According to the information available to the applicant, pulse laser equipment designed for cold ablation known at the priority date of the present application will yield an effective power of about 20 W in ablation. Then the laser pulse repetition frequency achieved with planar scanners may be limited to only a 4-MHz chopping frequency. As the frequency becomes higher, more and more pulses will overlap in the material to be vaporized. Thus the surface of the material will melt locally deeper and the next laser beam will be absorbed in the vaporizing plasma. If one attempts to increase the pulse frequency further, the scanners according to the prior art will cause a significant part of the pulses of the laser beam being directed uncontrollably onto the wall structures of the laser apparatus, and also into the ablated material in the form of plasma, having the net effect that the quality of the surface to be produced using the ablated matter will suffer as will also the production rate and, furthermore, the radiation flux hitting the target will not be uniform enough, which may affect the structure of the plasma produced, which thus may, upon hitting the surface to be coated, produce a surface of uneven quality. The problems become worse as the size of the plasma plume gets bigger. If it is possible to increase the scanning width, the power produced by the laser will be distributed across a larger area.

In arrangements according to the prior art, a change in the focus of the laser beam in the middle of ablation, relative to the material to be vaporized, is also problematic because it will immediately affect the quality of the plasma as the energy density of the pulse on the surface of the material will (normally) decrease, whereby vaporization/generation of plasma is no longer perfect. This results in low-energy plasma and unnecessarily large amounts of fragments/particles as well as a change in the surface morphology, weak adhesion of the coating and/or a change in the coating thickness.

Target materials to be vaporized will reflect part of the laser radiation back, whereby energy of the laser radiation will not be used for the ablation of the target material. Therefore, ablation thresholds of materials (the amount of energy needed for “lighting up” the matter, i.e. to start the generation of plasma) remain high, and the power needed for ablation remains high as well. Some materials cannot be ablated at all, and for some materials ablation is so weak that the plasma produced is of poor quality which leads to surfaces of low quality or modest material machining rates and cutting depths. A major part of the laser power is wasted or degrades the quality of the plasma by hitting it or, in the worst case, damages the laser apparatus when reflected.

Furthermore, high ablation thresholds of materials together with an increase in the laser power through an increased pulse frequency, for instance, will degrade the quality of surfaces achieved using machining (cutting, engraving) and vaporization of materials, in addition to making it more difficult to utilize laser ablation in the coating of large objects especially.

### SUMMARY OF THE INVENTION

So, present-day target materials used in laser ablation have such surface structures that they reflect a significant part of laser radiation hitting the surface part of the target material, for example. Target materials having a metal surface are especially problematic, but the problem applies equally to metal oxides and other materials, too. Since a significant portion of the radiation is reflected away, the amount of energy needed for ablation, the ablation threshold, becomes higher. This reduces the ablation rate and, hence, the machining speed as well as the production rate for plasma depositions. As laser apparatus have limited powers, some of the materials cannot be vaporized at all.

This invention pertains to a method for lowering the ablation threshold of a laser-ablated material by having on a surface of the laser-ablated material a structuring which reduces the reflection of a laser beam.

This invention further pertains to a laser-ablatable target material having on a surface of the laser-ablated material a structuring which reduces the reflection of a laser beam.

The present invention is based on a surprising notion that the ablation threshold of a target material (material to be vaporized) can be lowered by forming on a surface of the laser-ablated material a structuring which reduces the reflection of a laser beam. There are several techniques available for producing the structuring. The structuring may also be fabricated as part of the vaporization/machining process, meaning that the laser can be utilized for making a suitable structuring as an integrated part of production. The ablation threshold can be further lowered by heating the material to be vaporized and, for example, applying a chemical treatment such as oxidization, nitridization or carburization to modify the surface of the material to be vaporized so that it better absorbs the laser beam.

The present invention is also based on the surprising notion that by doping the material to be vaporized with one or more substances the ablation threshold of the material to be vaporized (ablated) is dramatically lowered. For example, aluminum oxide by itself has an ablation threshold of over 6 μJ/cm2. If it is doped with titanium oxide, the ablation threshold with the same laser parameters (1064 nm, 20 ps, 20 w) will become as low as 0.5 to 0.6 μJ/cm2. Another such compound is yttrium-stabilized zirconium oxide and yttrium aluminum oxide (YAG) which is easily vaporized as such, whereas pure aluminum oxide has a considerably higher vaporization threshold. The invention shall not be limited to these compounds, the underlying principle being that a material hard to ablate can be made more readily ablatable with considerably lower pulse energies by doping a hard-to-ablate substance with an “impurity”. Sometimes this “impurity”, or dopant, may even be useful from the point of view of the final properties of the surface structure produced from plasma. Typically the dopant will not reduce/degrade, at least not significantly, the hardness, uniformity or surface roughness properties of the surface produced.

The present invention has industrial significance in that the laser power needed in vaporization and vaporization-based deposition and surface-treatment processes (cutting and engraving, lithography) will be considerably lower. This also facilitates efficient vaporization of several hard-to-vaporize materials, such as aluminum oxide, on an industrial scale.

When coating large surfaces, wide scanning widths, preferably over 25 cm, are needed in order to achieve industrial production scales. The laser power available will then naturally be distributed across a larger area (wider scan line), and in order to vaporize the material, both the pulse repetition frequency and the laser power need to be increased. If one uses structured target materials according to the invention, the scanning width can be increased without the surface quality or the production rate or the cutting speed of the machined material requiring any significant increase in the laser power. Production will be energy-efficient and, thus, very environment-friendly. The scanning width and laser pulse repetition frequency can be increased by using a turbine scanner instead of a mirror scanner.

### DRAWINGS

The drawings presented here do not take a stand on the proportions of the target material to be ablated but illustrate some possible surface structures according to the invention.

FIG. 1 illustrates a structuring on an ablatable target material according to the invention,

FIG. 2 illustrates a structuring on an ablatable target material according to the invention,

FIG. 3 illustrates a structuring on an ablatable target material according to the invention,

FIG. 4 illustrates a structuring on an ablatable target material according to the invention,

FIG. 5 illustrates a structuring on an ablatable target material according to the invention,

FIG. 6 illustrates a structuring on an ablatable target material according to the invention,

FIG. 7 illustrates a structuring on an ablatable target material according to the invention,

FIG. 8 illustrates a structuring on an ablatable target material according to the invention,

FIG. 9 illustrates a structuring on an ablatable target material according to the invention,

FIG. 10 illustrates a structuring on an ablatable target material according to the invention,

FIG. 11 illustrates a structuring on an ablatable target material according to the invention,

FIG. 12 illustrates a structuring on an ablatable target material according to the invention,

FIG. 13 illustrates a structuring on an ablatable target material according to the invention,

FIG. 14 illustrates a structuring on an ablatable target material according to the invention,

FIG. 15 illustrates a structuring on an ablatable target material according to the invention. Here the structuring is produced on a surface of a lamella-like target material,

FIG. 16 illustrates a feed module of a tape-like target material of 300 mm according to an example according to the invention,

FIG. 17 illustrates a manner according to the invention of placing in parallel four modular feed modules for a tape-like 300-mm target material, facilitating the coating of targets having a width of 1200 mm, for instance,

FIG. 18 illustrates in more detail the structure of a tape feed apparatus for a target material according to the invention,

FIG. 19 illustrates an embodiment of a turbine scanner,

FIG. 20 illustrates an overlapping scan pattern produced with a turbine scanner and its deflected mirrors.

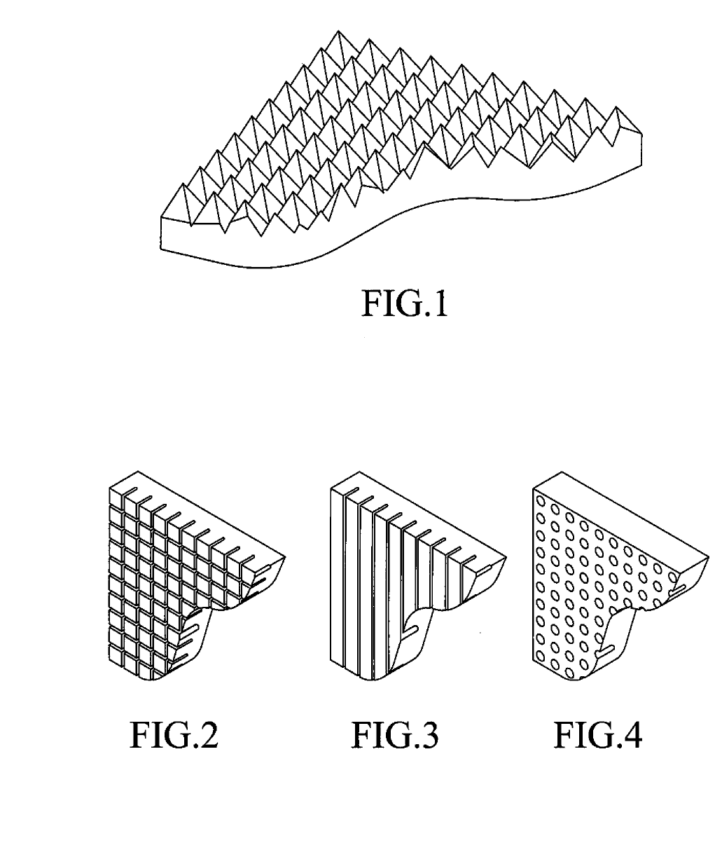

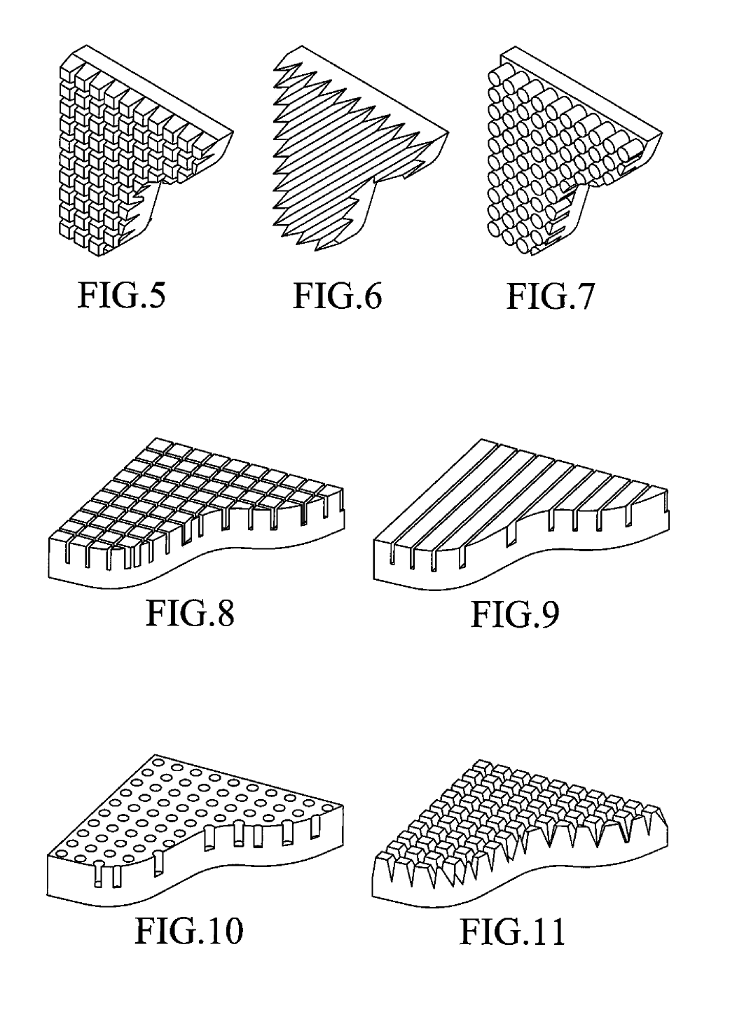

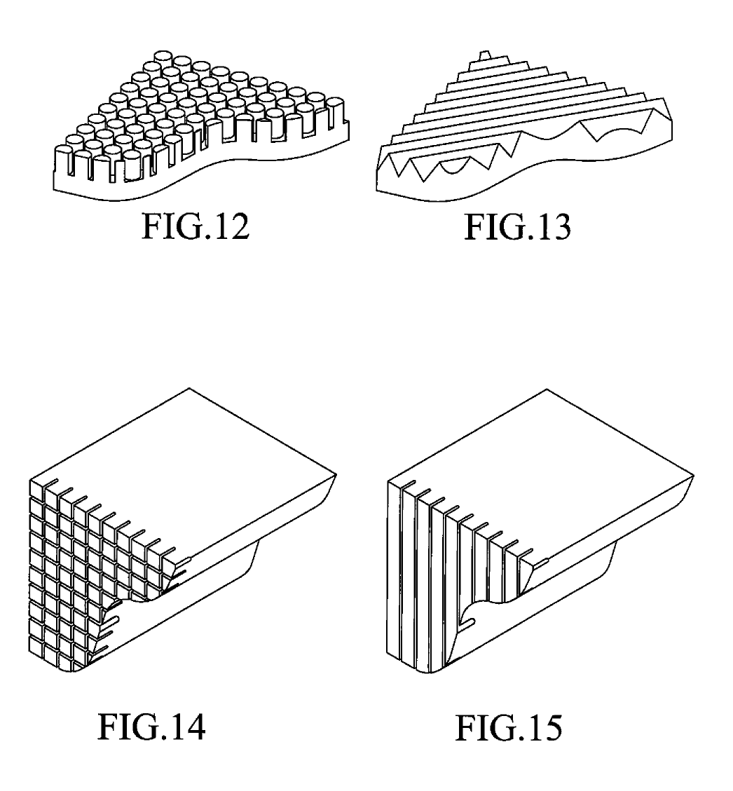

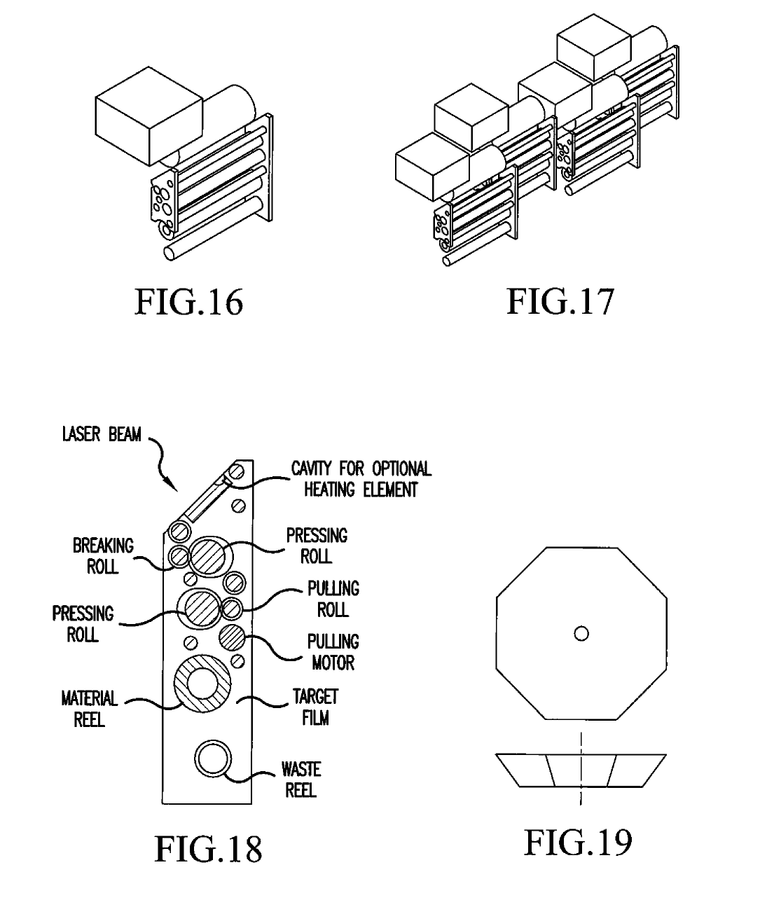

### DETAILED DESCRIPTION OF THE INVENTION

The invention pertains to a method for lowering the ablation threshold of a laser-ablatable material by having on a surface of the laser-ablatable material a structuring which reduces the reflection of a laser beam. As reflection is reduced, the material to be ablated will absorb a bigger portion of the laser beam's energy which in turn will lower the ablation threshold of the material. Ablation of the material thus requires a lower power of the laser beam, boosting the production rate of the ablation itself. This is industrially beneficial both in material deposition and machining applications. The quality of the plasma produced is better and more easily controllable, the surfaces produced have a better quality and the machining result is better. Some materials, which earlier could not be utilized as laser-ablatable material, can now be used.

According to the invention, a surface may refer to a surface or a 3D material. No geometric or three-dimensional limitations are imposed here on a “surface”. Thus, according to the invention, not only is it possible to coat 3D materials but also to create them.

So, when a target is ablated with laser pulses, a molecular-level plasma plume is produced.

Let it be clarified that atomic plasma also refers to a gas at least partly in an ionized state which may also include parts of an atom still containing electrons bonded to the nucleus through electrical forces. So, once-ionized neon, for example, could be considered atomic plasma. Naturally, also particle groups comprised of electrons and pure nuclei as such, separated from each other, are counted as plasma. Pure good plasma thus contains only gas, atomic plasma and/or plasma, but not solid fragments and/or particles, for instance.

Let it be noted about using pulses in pulsed laser deposition (PLD) applications that the longer the laser pulse in PLD, the lower the plasma energy level and atom speeds of the matter vaporized from the target as the pulse hits the target. Conversely, the shorter the pulse, the higher the energy level of the vaporized matter and the atom speeds in the jet of matter. On the other hand this also means that the plasma obtained in the vaporization is more uniform and homogeneous, without precipitations and/or condensation products, such as fragments, clusters, micro- or macro-particles, of the solid or liquid phase. In other words, the shorter the pulse and the higher the repetition frequency, provided that the ablation threshold of the material to be vaporized is exceeded, the better the quality of the plasma produced.

The effective depth of the heat pulse from a laser pulse hitting the surface of a material varies considerably between laser systems. This affected area is called the heat affected zone (HAZ). The HAZ is substantially determined by the power and duration of the laser pulse. For example, a nanosecond pulse laser system typically produces pulse energies of a few hundred mJ or more, whereas a picosecond laser system produces pulse energies of 1 to 10 μJ. If the repetition frequency is the same, it is obvious that the HAZ of the pulse produced by the nanosecond laser system, with a power of over 1000 times higher, is significantly deeper than that of the picosecond pulse. Furthermore, a significantly thinner ablated layer has a direct effect on the size of particles potentially coming loose from the surface, which is an advantage in so-called cold ablation methods. Nano-sized particles usually will not cause major deposition damages, mainly holes in the coating when they hit the substrate. In an embodiment of the invention, fragments in the solid (also liquid, if present) phase are picked out by means of an electric and/or magnetic field. This can be achieved using a collecting electric field and, on the other hand, keeping the target electrically charged so that fragments moving with a lower electrical mobility can be directed away from the plasma in the plasma jet. Magnetic filtering operates by deflecting the plasma jet so that the particles can be separated from the plasma. The structuring according to the invention reduces reflection with any laser equipment. The structuring which reduces reflection of the laser beam is especially advantageous when using pulse lasers and, furthermore, especially advantageous when using cold-work lasers such as a picosecond laser.

Another cold-work laser is the femtosecond laser, but the higher pulse repetition frequencies and, hence, faster production rates make the picosecond laser industrially more useful. The power of the picosecond laser is typically at least 10 W, advantageously at least 20 W, and preferably at least 50 W. No upper limit is here imposed on the power of the laser apparatus.

The ablation threshold of a laser-ablatable material can be lowered e.g. in such a manner that the transverse diameter of an individual structure in the structuring on the material is 0.1 μm to 1 mm, advantageously 0.3 μm to 100 μm, and preferably 0.5 μm to 1.5 μm.

Especially when using pulse lasers, preferably picosecond lasers, for material ablation, the transverse diameter of an individual structure on the surface of the material to be ablated is equal to or smaller than the measure of the wavelength of the laser light used in the ablation. A typical wavelength used in picosecond lasers is 1064 nm, or about one micrometer.

For example, when using picosecond lasers for ablation, a molten layer of 1 to 2 μm is typically formed on the surface of the material ablated. Thus the diameter of an individual structure in the direction of depth may be from 0.1 μm to 1 mm, advantageously 0.3 μm to 100 μm, but absolutely preferably 0.5 μm to 3 μm especially in cold ablation applications. Choice of an optimal structuring also depends on the quality required of the coating.

Since the most commonly used wavelength of picosecond lasers is 1064 nm and the layer of molten material is typically advantageously not more than two micrometers thick, the diameter of an individual structure in the direction of depth is advantageously not more than twice the wavelength of the laser light used.

In an especially advantageous embodiment of the invention the laser-ablatable material is heated in connection with the ablation. This lowers the ablation threshold of the material to be ablated. An especially advantageous temperature for the material is achieved when it is heated towards the temperature of the conductivity threshold of the material. This is the characteristic temperature of each material in which the electrical conductivity of the material increases dramatically. The advantageous temperature in question always comes before the melting point of the material to be ablated.

In certain advantageous embodiments of the invention the material to be ablated is composed of a metal, metal alloy, glass, stone, ceramic, synthetic polymer, semi-synthetic polymer, paper, cardboard, natural polymer, composite material, or inorganic or organic monomer or oligomer.

So, the material to be ablated is advantageously intended for producing surfaces. Surfaces may be produced using one or more target materials and one or more laser beams. It is also possible to produce surface structures not known before. The invention does not limit the materials to be ablated or materials to be coated. They can be freely chosen among all possible materials.

In another advantageous embodiment of the invention the deposited surface is produced as follows: reactive material is brought into a plasma plume made of ablated material, which reactive material reacts with the ablated material in the plasma plume and the compound(s) thus generated form the surface on the substrate (material to be coated).

The material to be ablated may also be a material to be machined. For such a surface to be machined, the structuring may also be produced only on those particular spots which are to be machined. The machining may comprise engraving or through-cutting, for example.

In another especially advantageous embodiment of the invention the material to be ablated is treated chemically or thermally so that its ablation threshold is lowered. This can be achieved by mixing into the material to be ablated another material which lowers the ablation threshold, i.e. the material to be ablated is made a composite material all components of which are advantageously ablatable. This can also be achieved by heating the target material so that the surface structure of the material is more easily broken in ablation. Involvement of a reactive gas will boost the effect.

Examples of suitable composite materials include andalusite, moissanite, kyanite, sillimanite, and mullite. Furthermore, the ablation thresholds of some materials are dramatically lowered when even a small amount of yttrium, for instance, is added in them. Such compounds include yttrium-stabilized zirconium oxide or yttrium-stabilized aluminum oxide (YAG), indium tin oxide (ITO), and aluminum titanium oxide (ATO).

One definition of “composite” can be found in the Polymer Science Dictionary (Alger, M. S. M., Elsevier Applied Science, 1990, p. 81), and based on that, a definition of “composite material” could read as follows: “Solid material composed of a combination of one or more simple (or monolithic) materials in which the individual constituents retain their distinct identities. A composite material has different properties than its constituent materials; the term composite often implies enhanced physical properties as the main technological objective is to produce materials having superior properties in comparison with the constituent materials of the composite. A composite material also has a heterogeneous structure formed of the phases of the two or more components of the composite. The phases may be continuous phases or one or more of the phases may be a dispersed phase within a continuous matrix.”

In another advantageous embodiment of the invention the surface layer of the material to be ablated is treated chemically or thermally so that the ablation threshold of the material is lowered. This can be achieved e.g. by oxidizing, nitridizing or carburizing the surface layer of the material to be ablated so that the surface of the material will reflect less laser radiation. As said, this can also be achieved by heating the target material so that he surface structure of the material is more easily broken in ablation. Involvement of a reactive gas will boost the effect.

In an embodiment of the invention the material to be ablated is in the form of a lamella (a sheet-like target). Such lamella structures can be placed in a vaporizing chamber (where ablation takes place) in such a manner that a new lamella structure is always pushed into the place of the previous, already-used lamella structure. The lamella sheets are advantageously just so thick that it is technically possible to feed them. This method of feeding the material is very suitable for thin, structured ceramic plates of aluminum oxide, for example. Let it be noted that the fabrication of large targets is usually laborious and expensive.

In yet another especially advantageous embodiment of the invention the material to be ablated is in the form of a film or tape. The thickness of such a film/tape material to be ablated is from 1 μm to 5 mm, advantageously 20 μm to 1 mm, and preferably 50 μm to 200 μm.

In an embodiment of the invention the target material is a structured version, in accordance with the invention, of a prior-art rotating target material (U.S. Pat. No. 6,372,103).

The structuring of the material to be ablated may have been done already in connection with the manufacture of the target material, by means of compression rolls or other lithographic techniques, for example. The structuring of the surface may also be done using a laser. In that case the structuring may be integrated in the ablation process, as a preliminary stage thereto. The structuring may be done either so as to cover the whole surface of the target or just at desired spots, in an embodiment of the invention only at those spots that are to be cut/engraved.

Lowered ablation thresholds enable laser ablation also in normal atmospheric pressure or in a gaseous atmosphere such as nitrogen, oxygen, carbon dioxide or hydrocarbon. In that case, the target material and, particularly, its surface can be treated chemically with a laser so that the lowering of the ablation threshold can be integrated in the coating or machining process. Furthermore, the invention can be implemented in a vacuum in which the pressure is 10⁻¹ to 10⁻¹² atm. So, in a method according to the invention, a surface of high quality and strong enough for the application in question, having the desired optical properties (colored or transparent), can be achieved in such a manner that a substrate is coated using laser ablation in roughly a vacuum or even in a gaseous atmosphere of the normal atmospheric pressure.

For the quality of the plasma to remain as uniform as possible it is advantageous in an embodiment of the invention that the material is ablated by a laser beam in such a manner that material is vaporized substantially all the time at a spot which has not been significantly ablated before.

This can be achieved by moving the target so that ablation is all the time directed to a fresh surface. In current known methods the material preform is usually in the form of a thick bar or sheet. In these, a zoom focusing lens must be used or the material preform must be moved toward the laser beam as the material preform gets consumed. Even an attempt to implement this is already extremely difficult and expensive, if at all possible in a manner sufficiently reliable, and even then the quality varies greatly, whereby precise control is almost impossible, the manufacture of a thick preform is expensive and so on.

As the laser beam control technique is limited due to, among other things, the scanners according to the prior art, this cannot be done without problems, especially when increasing the pulse frequency of the laser apparatus. If one attempts to increase the pulse frequency to 4 MHz or higher, the scanners according to the prior art will cause a significant part of the pulses of the laser beam being directed uncontrollably onto the wall structures of the laser apparatus, and also into the ablated material in the form of plasma, having the net effect that the quality of the surface to be produced will suffer as will also the production rate and, furthermore, the radiation flux hitting the target will not be uniform enough, which may affect the structure of the plasma, which thus may, upon hitting the surface to be coated, produce a surface of uneven quality. If the laser beam hits completely or partly a surface which already has been ablated, the distance between the target and substrate will change at these pulses. When pulses directed to the target hit spots on the target which have already been ablated, the pulses will remove different amounts of material so that particles of several microns will be ablated from the target. Such particles, when hitting the substrate, considerably degrade the quality of the surface produced and, therefore, the properties of the product.

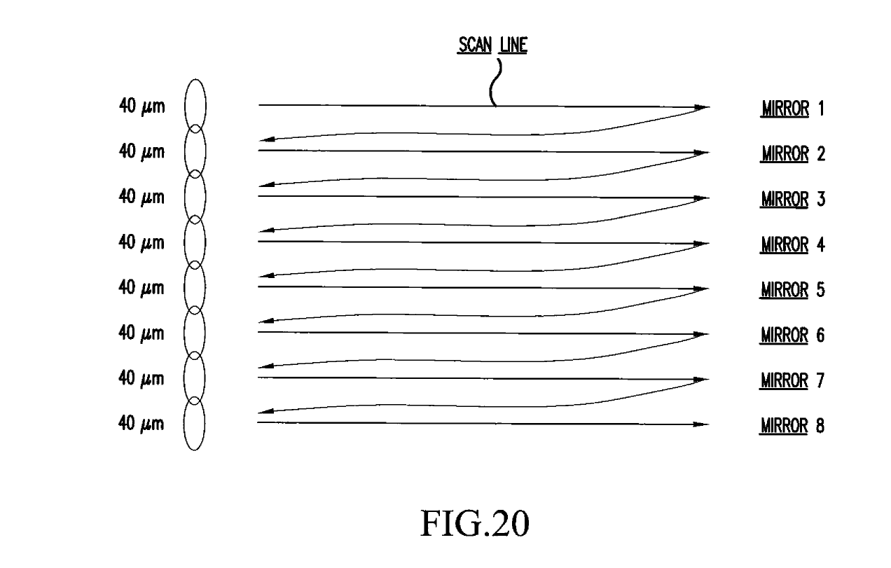

Another problem in prior-art solutions is the scanning width. These solutions use line scanning in mirror film scanners whereby, theoretically, one could think that it is possible to achieve a nominal scan line width of about 70 mm, but in practice the scanning width may problematically remain even around 30 mm, whereby the fringe regions of the scanning area may be left non-uniform in quality and/or different from the central regions. Scanning widths this small also contribute to the fact that the use of present-day laser equipment in surface treatment applications for large and wide objects is industrially unfeasible or technically impossible to implement. In order to facilitate a maximum production efficiency as well as coatings and cutting results of good and even quality, the laser beam is directed to the material to be ablated via a turbine scanner in an especially advantageous embodiment of the invention. The turbine scanner and its benefits especially in laser applications based on cold ablation are described e.g. in applications FI20050747 and FI20060182. FIG. 19 illustrates an embodiment of the turbine scanner. FIG. 20 in turn illustrates an overlapping scan pattern produced with the turbine scanner and its deflected mirrors. In this solution the scan patterns overlap only partially so that the quality of the plasma (and that of the machining) is excellent, avoiding the massive overlapping of pulses which occurs in conventional scanners especially at high repetition frequencies. The turbine scanner solves power transmission problems associated with earlier planar mirror scanners in such a manner that target material can be vaporized at a pulse power high enough, producing plasma of a uniform and good quality and, therefore, surfaces and 3D structures of a good quality. The turbine scanner itself facilitates scanning widths broader than before and, hence, the coating of larger areas by one and the same laser equipment. The machining speed is thus good and the quality of the surface produced has a uniform quality.

The turbine scanner thus enables an increase in the laser's repetition frequency (e.g. over 4 MHz) retaining the controllability of the beam. This results in a higher laser power with the various benefits associated with it. Using the turbine scanner, the scanning width directed to the target is 1 mm to 800 mm, advantageously 100 mm to 400 mm, and preferably 150 mm to 300 mm. As the scanning width increases, the power of the laser is distributed across a larger area to be vaporized. Thus, lowering the ablation threshold of the material is especially advantageous when using broad scanning widths. Lowering the ablation threshold also facilitates an efficient coating of a high quality of large objects at a reasonably low laser power such as 20 watts.

The invention also pertains to a laser-ablatable material target and/or target material a surface of which has a structuring which reduces the reflection of the laser beam. According to an advantageous embodiment of the invention the transverse diameter of an individual structure in the structuring is 0.1 μm to 1 mm, advantageously 0.3 μm to 100 μm, and preferably 0.5 μm to 1.5 μm. Thus, the transverse diameter of an individual structure is advantageously equal to or smaller than the measure of the wavelength of the laser light used in the ablation. Typically, the wavelength of picosecond lasers, for instance, is 1064 nm. In an embodiment of a material target and/or target material according to the invention the diameter in the direction of depth of an individual structure is 0.1 μm to 1 mm, advantageously 0.3 μm to 100 μm, and preferably 0.5 μm to 3 μm. Therefore, when using picosecond lasers, for example, the diameter in the direction of depth of an individual structure is advantageously not more than two times the measure of the wavelength of the laser light used.

According to an embodiment of the invention the target material comprises surface formations that are arranged additionally to enhance transference of the plasma from the target, which plasma is released from the target from it from such an ensemble of surface formations that are in the area of the target that is being ablated away by a cold-work laser. According to an embodiment of the invention such formations comprise a narrowing target material region, arranged to narrow outwards from the target's surface. According to an embodiment the formations can be tilted and/or skewed. The shape of the formation can be in one embodiment conical, but in another embodiment round. According to an embodiment of the invention the formations are ridge like, but according to other respective embodiment like pyramids or prisms or bumbs.

According to the invention the material target may be such that the material ablated thereof is metal, metal alloy, glass, stone, ceramic, synthetic polymer, semi-synthetic polymer, paper, cardboard, natural polymer, composite material, inorganic or organic monomer or oligomer.

Examples of some suitable composite materials include andalusite, moissanite, kyanite, sillimanite, and mullite. Furthermore, the ablation thresholds of some materials are dramatically lowered when even a small amount of yttrium, for instance, is added in them. Such compounds include yttrium-stabilized zirconium oxide or yttrium-stabilized aluminum oxide (YAG), indium tin oxide (ITO) and aluminum titanium oxide (ATO), and element carbon.

According to an embodiment of the invention the material target may be treated chemically such that its ablation threshold is lowered. In an embodiment, this may be achieved by doping the material with another material which lowers the ablation threshold, as described above. In another advantageous embodiment of the invention the surface layer of the material to be ablated is treated chemically so that the ablation threshold of the material is lowered. One way is to treat the ablatable material chemically such that the capacity of the surface to absorb laser radiation is enhanced. This can be achieved e.g. by oxidizing, nitridizing or carburizing the surface layer of the material to be ablated. When the material has once “lit up”, less energy is needed to ablate the material, i.e. less energy is needed for the vaporization itself than for starting the vaporization of the material. The lighting-up may require a pulse energy of 5 μJ, for example, but the ablation itself will progress with a pulse energy of 0.6 μJ. A rough analogy would be the lighting-up of a fire in the fire-place, for instance.

In accordance with the invention, the structuring of the material to be ablated may have been done already in connection with the manufacture of the target material, by means of compression rolls or other lithographic techniques, for example. The structuring of the surface may also have been done using a laser. The structuring may be integrated in the ablation process, as a preliminary stage thereto. The structuring may have been done either so as to cover the whole surface of the target or just at desired spots, in an embodiment of the invention only at those spots that are to be cut/engraved.

A target material according to the invention is in the form of a lamella, thread, or shaped thread. This may be e.g. a little thicker, sheet-like piece of the material to be ablated. Thickness of the sheet may vary from micrometers to several centimeters. It is preferable to use lamella structures as thin as possible. The lamellae may be arranged in the vaporizing unit such that when one lamella is technically used up, the next one is automatically placed so as to be vaporized/machined. Apart from serving as a source of material for deposition plasma the lamella may also serve as an uncut/unengraved preform of the product.

Since the target materials are valuable and advantageously only the virginal surface part is used of the target surface, it is industrially advantageous to use targets as thin as possible. Tape-form target materials are naturally considerably cheaper than current target materials (big, solid targets) and also better available because of the easier and cost-efficient manufacturing methods.

So, in a preferable embodiment of the invention the target material is in the form of film or tape.

Let it be noted that the target material according to the invention and the method of using it for lowering the ablation threshold of the material are not limited solely to lamella and/or tape/film feed, but apply to all target materials used in laser ablation. Thickness of the tape/film may be e.g. 1 μm to 5 mm, advantageously 20 μm to 1 mm, and preferably 50 μm to 200 μm. FIGS. 17 and 18 illustrate feeding arrangements of a tape-like target material according to the invention.

In such an advantageous embodiment the film/foil is then e.g. in the reel form, as shown in FIG. 17. When the tape has been first longitudinally vaporized from beginning to end along the width of one laser plume, the tape/foil is moved e.g. sideways to such an extent that a completely new track can be formed. This can be continued until the foil/film is completely used up in the direction of the breadth. The essential idea of this system is naturally that the vaporization result is always constant and of top quality because the source material remains constant all the time.

Thus, the method according to the invention can be used to produce, very cost-effectively from an industrial standpoint (low laser power and in many applications lower volumes than in the prior art or even in normal atmosphere or gas phase), surfaces and/or 3D materials having various functions. Such surfaces include e.g. very hard and scratch-resistant surfaces and 3D materials in various glass and plastic products (lenses, eyeglasses, sunglasses, monitor shields, windows in vehicles and buildings, glassware in laboratories and households, art glass), especially advantageous optical coatings including andalusite, moissanite, kyanite, sillimanite and mullite; YAG, MgF₂, SiO₂, TiO₂, Al₂O₃, ITO and ATO, and especially advantageous hard coatings include various metal oxides, carbides and nitrides and of course diamond coatings; various metal products and their surfaces, such as shell structures for telecommunication devices, roofing sheets, decoration and construction panels, linings, and window frames; kitchen sinks, faucets, ovens, coins, jewels, tools and parts thereof; engines of automobiles and other vehicles and parts thereof, metal cladding in automobiles and other vehicles, and painted metal surfaces; objects with metal surfaces used in ships, boats and airplanes, aircraft turbines, and combustion engines; bearings; forks, knives, and spoons; scissors, carving knives, rotary blades, saws, and all types of cutters with metal surfaces, screws, and nuts; metallic processing means used in chemical industry processes, such as reactors, pumps, distilling columns, containers, and frame structures having metal surfaces; oil, gas and chemical pipes and various valves and regulating units; parts and drill bits of oil drilling equipment; pipes for transporting water; weapons and their parts, bullets, and cartridges; metallic nozzles susceptible to wear, such as papermaking machine parts susceptible to wear, e.g. parts of the coating paste spreading equipment; snow pushers, shovels, and metallic structures of playground equipment; roadside railing structures, traffic signs and posts; metal cans and vessels; surgical equipment, artificial joints and implants and instruments; cameras and video cameras and metallic parts in electronic devices susceptible to oxidation and wear, and spacecraft and their cladding solutions resistant to friction and high temperatures.

Yet other products fabricated in accordance with the invention may include surfaces and 3D materials resistant to corrosive chemical compounds, semiconductor materials, LED materials, pigment materials and surfaces made thereof which change color according to the viewing angle, already-mentioned parts of laser equipment and diode pumps, such as beam expanders and the light bar in the diode pump, jewel materials, surfaces of medical products and medical products in 3D shapes, self-cleaning surfaces, various products for the construction industry such as already-mentioned pollution- and/or moisture-resistant and, if necessary, self-cleaning stone and ceramic materials (coated stone products and products onto which a stone surface has been deposited), dyed stone products, e.g. marble dyed green in accordance with an embodiment of the invention or self-cleaning sandstone.

Further products fabricated according to the invention may include anti-reflective (AR) surfaces e.g. in various lens and monitor shielding solutions, coatings protective against UV radiation, and UV-active surfaces used in the purification of water, solutions or air. So, the thickness of the surfaces produced can be controlled. Therefore, the thickness of a diamond or carbon nitride surface formed according to the invention may be 1 nm to 3000 nm, for example. In addition, the diamond surface can be made extremely even. So, the evenness of a diamond surface (and oxide surfaces) may be on the order of ±25 nm, advantageously it is ±10 nm, and in some demanding, low-friction applications it can be adjusted to ±0.2 nm. The diamond surface according to the invention not only prevents the underlying surfaces from being mechanically worn but also prevents them from being subjected to chemical reactions. The diamond surface prevents metal oxidation, for instance, and thus the destruction of their decorative or other function. Furthermore, the diamond surface protects the underlying surfaces against acids and alkalis. The diamond surface according to the invention not only prevents the underlying surfaces from being mechanically worn but also prevents them from being subjected to chemical reactions. The diamond surface prevents metal oxidation, for instance, and thus the destruction of their decorative or other function. Furthermore, the diamond surface protects the underlying surfaces against acids and alkalis. In certain applications decorative metal surfaces are desired. Some especially decorative metals or metal alloys utilizable as targets according to the invention include gold, silver, chrome, platinum, tantalum, titanium, copper, zinc, aluminum, iron, steel, zinc black, ruthenium black, ruthenium, cobalt, vanadium, titanium nitride, titanium aluminum nitride, titanium carbon nitride, zirconium nitride, chrome nitride, titanium silicon carbide, and chrome carbide. Of course, these compounds can be used to achieve other properties, too, such as wear-resistive surfaces or surfaces protective against oxidation or other chemical reactions.

Some metal alloys worth mentioning here include metal oxides, nitrides, halides and carbides, but the metal alloys are not limited to these.

Different oxide surfaces fabricated according to the invention include aluminum oxide, titanium oxide, chrome oxide, zirconium oxide, tin oxide, tantalum oxide, various doped versions of these, such as titanium aluminum oxide, yttrium-stabilized zirconium aluminum oxides, ITO, ATO, and the combinations of these in composites with each other or metals, diamond, carbides or nitrides, for instance. These materials, too, can be manufactured according to the invention also from metals using a reactive gaseous atmosphere.

1. A method for lowering the ablation threshold of a laser-ablatable material, characterized in that on a surface, of the material ablatable by cold-work laser, there is a structuring which reduces the reflection of the laser beam.

2. A method according to claim 1, characterized in that the laser apparatus used in the ablation of the material is a cold-work laser, such as a picosecond laser

3. A method according to claim 1, characterized in that the power of the laser apparatus is at least 10 W, advantageously at least 20 W, and preferably at least 50 W.

4. A method according to claim 1, characterized in that the transverse diameter of an individual structure in the structuring is 0.1 μm to 1 mm, advantageously 0.3 μm to 100 μm, and preferably 0.5 μm to 1.5 μm.

5. A method according to claim 1, characterized in that the transverse diameter of an individual structure is equal to or smaller than the measure of the wavelength of the laser light used in the ablation.

6. A method according to claim 1, characterized in that the diameter in the direction of depth of an individual structure is 0.1 μm to 1 mm, advantageously 0.3 μm to 100 μm, and preferably 0.5 μm to 3 μm.

7. A method according to claim 6, characterized in that the diameter in the direction of depth of an individual structure is not more than twice the measure of the wavelength of the laser light used in the ablation.

8. A method according to claim 1, characterized in that the laser-ablatable material is heated in connection with the ablation.

9. A method according to claim 8, characterized in that the laser-ablatable material is heated toward the conductivity threshold temperature of the material.

10. A method according to claim 1, characterized in that the material to be ablated, by a cold work laser, is composed of metal, metal alloy, glass, stone, ceramic, synthetic polymer, semi-synthetic polymer, paper, cardboard, natural polymer, composite material, inorganic or organic monomer or oligomer.

11. A method according to claim 1, characterized in that the laser-ablatable material is treated chemically such that its ablation threshold is lowered.

12. A method according to claim 11, characterized in that the material to be ablated is doped with a material which lowers the ablation threshold.

13. A method according to claim 11, characterized in that the surface layer of the material to be ablated is treated chemically or thermally so that the ablation threshold of the material is lowered.

14. A method according to claim 13, characterized in that the surface layer of the material to be ablated is oxidized, nitridized or carburized.

15. A method according to claim 1, characterized in that the material to be ablated is in the form of a lamella or thread.

16. A method according to claim 1, characterized in that the material to be ablated is in the form of a film or tape.

17. A method according to claim 16, characterized in that the thickness of the material to be ablated is 1 μm to 5 mm, advantageously 20 μm to 1 mm, and preferably 50 μm to 200 μm.

18. A method according to claim 1, characterized in that the laser ablation is performed in normal atmospheric pressure or in a gaseous atmosphere such as nitrogen, oxygen, carbon dioxide or hydrocarbon.

19. A method according to claim 1, characterized in that the laser ablation is performed in a vacuum in which the pressure is 10⁻¹ to 10⁻¹² atm.

20. A method according to claim 1, characterized in that material is ablated by a laser beam so that material is vaporized essentially all the time at a spot which has not yet been significantly ablated.

21. A method according to claim 1, characterized in that the laser beam is directed to the ablatable material through a turbine scanner.

22. A method according to claim 21, characterized in that the scanning width directed to the target is 1 mm to 800 mm, advantageously 100 mm to 400 mm, and preferably 150 mm to 300 mm.

23. A target material ablatable by laser, characterized in that on a surface of the laser-ablatable material by cold-work laser, there is a structuring which reduces the reflection of a laser beam.

24. A target material according to claim 23, characterized in that the transverse diameter of an individual structure in the structuring is 0.1 μm to 1 mm, advantageously 0.3 μm to 100 μm, and preferably 0.5 μm to 1.5 μm.

25. A target material according to claim 23, characterized in that the transverse diameter of an individual structure is equal to or smaller than the measure of the wavelength of the laser light used in the ablation.

26. A target material according to claim 23, characterized in that the diameter in the direction of depth of an individual structure is 0.1 μm to 1 mm, advantageously 0.3 μm to 100 μm, and preferably 0.5 μm to 3 μm.

27. A target material according to claim 26, characterized in that the diameter in the direction of depth of an individual structure is not more than twice the measure of the wavelength of the laser light used in the ablation.

28. A target material according to claim 23, characterized in that the material to be ablated is composed of metal, metal alloy, glass, stone, ceramic, synthetic polymer, semi-synthetic, polymer, paper, cardboard, natural polymer, composite material, or inorganic or organic monomer or oligomer.

29. A target material according to claim 23, characterized in that the laser-ablatable material is treated chemically or thermally such that its ablation threshold is lowered.

30. A target material according to claim 29, characterized in that the material to be ablated is doped with a material which lowers the ablation threshold.

31. A target material according to claim 29, characterized in that the surface layer of the material to be ablated is treated chemically such that the ablation threshold of the material is lowered.

32. A target material according to claim 31, characterized in that the surface layer of the material to be ablated is oxidized, nitridized or carburized.

33. A target material according to claim 23, characterized in that the target material is in the form of a lamella.

34. A target material according to claim 23, characterized in that the target material is in the form of a film or tape.

35. A target material according to claim 34, characterized in that the thickness of the target material is 1 μm to 5 mm, advantageously 20 μm to 1 mm, and preferably 50 μm to 200 mm.
